(19) United States
(12) Patent Application Publication
(10) Pub. No.: US 2023/0096333 A2
(43) Pub. Date: Mar. 30, 2023

(54) NAVIGATION APPARATUS

(71) Applicant: UNITED STATES GOVERNMENT AS REPRESENTED BY THE DEPARTMENT OF VETERANS AFFAIRS, Washington, DC (US)

(72) Inventor: Brian Higgins, US, US (US)

(21) Appl. No.: 17/632,228

(22) PCT Filed: Sep. 28, 2020
(86) PCT No.: PCT/US20/53125

§ 371 Date: Feb. 1, 2022

Related U.S. Application Data
(60) Provisional application No. 62/907,037, filed on Sep. 27, 2019.

(51) Int. Cl. A61H 3/06; G01S 17/93; G01S 19/01; G01S 15/93; G01S 15/86

(52) U.S. Cl. CPC A61H 3/061; A61H 3/068; G01S 17/93; G01S 19/01; G01S 15/93; G01S 15/86; A61H 2201/1207; A61H 2201/0157; A61H 2201/5092; A61H 2201/5058; A61H 2201/0173; A61H 2201/5012; A61H 2003/063; A61H 2201/5048

(57) ABSTRACT

Methods, systems, and apparatuses are described that are configured for determining a path of an apparatus, engaging a motor to cause the apparatus to proceed along the path, receiving one or more of LIDAR data, ultrasonic data, or optical flow data, determining, based on one or more of the LIDAR data, the ultrasonic data, or the optical flow data, one or more objects in the path of the apparatus, and engaging the motor to cause the apparatus to avoid the one or more objects.

### CROSS-REFERENCE TO RELATED APPLICATION

This application claims the benefit of U.S. Provisional Application No. 62/907,037, filed Sep. 27, 2019, which is hereby incorporated by reference in its entirety.

### BACKGROUND

Traditional white canes are used by the visually impaired or those that need assistance in walking. Visually impaired persons typically walk with a white cane in order to feel the space immediately in front of them so as to sense where he or she is walking. There are limitations to the use of a white cane in that the user may not know exactly where he or she is going, may get lost in the course of feeling the path which they are walking, or may collide with objects in their path.

### SUMMARY

In an embodiment, an apparatus is described, comprising a wheel, an axle extending from at least one side of the wheel, a motor configured to rotate the wheel, a walking cane connected to the axle at a proximal end, the walking cane extending away from the axle toward a handle positioned at a distal end of the walking cane, the handle configured to be gripped by an operator, a Light Detection and Ranging (LIDAR) sensor, affixed to the walking cane, configured for detecting an environment in a path of the apparatus and generating LIDAR data, an ultrasonic sensor affixed to the walking cane, configured for detecting the environment in the path of the apparatus and generating ultrasonic data, an optical flow sensor affixed to the walking cane, configured for detecting objects and determining a pattern of apparent motion associated with the environment in the path of the apparatus caused by the motion of the optical flow sensor relative to the detected objects and generating optical flow data, a computing device affixed to the walking cane, wherein the computing device is configured to determine the path of the apparatus, engage the motor to cause the apparatus to proceed along the path, receive the LIDAR data, the ultrasonic data, and the optical flow data, determine, based on one or more of the LIDAR data, the ultrasonic data, or the optical flow data, one or more objects in the path of the apparatus, and engage the motor to cause the apparatus to avoid the one or more objects in the path.

In an embodiment, methods, systems, and apparatuses are provided for determining a path of an apparatus, engaging a motor to cause the apparatus to proceed along the path, receiving one or more of LIDAR data, ultrasonic data, or optical flow data, determining, based on the one or more of the LIDAR data, the ultrasonic data, or the optical flow data, one or more objects in the path of the apparatus, and engaging the motor to cause the apparatus to avoid the one or more objects.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

To easily identify the discussion of any particular element or act, the most significant digit or digits in a reference number refer to the figure number in which that element is first introduced.

FIG. 1 illustrates an exemplary system;

FIG. 2 illustrates an exemplary device;

FIG. 3 illustrates an exemplary system;

FIG. 4 illustrates an exemplary wheel assembly;

FIG. 5 illustrates an exemplary process; and

FIG. 6 illustrates an exemplary method.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes—from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Hereinafter, various embodiments of the present disclosure will be described with reference to the accompanying drawings. As used herein, the term “user” may indicate a person who uses an electronic device.

In an embodiment, a smart cane is described. The smart cane may be configured to scan a surface in proximity to the smart cane. The surface is a primary area of focus for autonomous navigational guidance travel for the blind. One or more sensors may be used to scan the surface. The one or more sensors may include but are not limited to an ultrasonic sensor, a Light Detection and Ranging (LIDAR) sensor, and an optical flow sensor. The one or more sensors may be configured to enable the smart cane for autonomous travel.

The smart cane may comprise a motorized wheel (e.g., a wheel assembly) in contact with the surface. The motorized wheel may be controlled by navigational software in order to traverse a route. The motorized wheel may receive guidance information from a processor of the smart cane. The processor of the smart cane may receive guidance information (e.g., wirelessly) from an external computing device, such as a smartphone, tablet, and/or smartwatch. For example, the processor may receive map data and/or directions from the external computing device. The motorized wheel may cause the apparatus to move in a direction so as to traverse the path and/or avoid an obstacle such as an object detected by the one or more sensors.

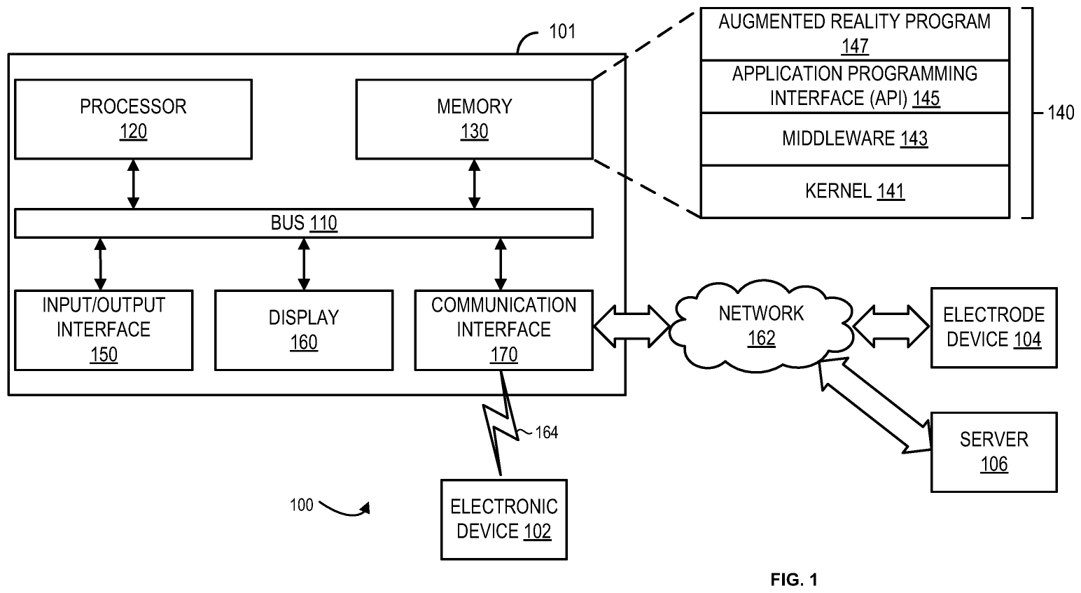

FIG. 1 illustrates a network environment including an electronic device (e.g., smartphone) configured for control one or more guidance systems of another electronic device (e.g., the smart cane) according to various embodiments. Referring to FIG. 1, an electronic device 101 in a network environment 100 is disclosed according to various exemplary embodiments. The electronic device 101 may include a bus 110, a processor 120, a memory 130, an input/output interface 150, a display 160, and a communication interface 170. In a certain exemplary embodiment, the electronic device 101 may omit at least one of the aforementioned constitutional elements or may additionally include other constitutional elements. The electronic device 101 may be, for example, a mobile phone, a tablet computer, a laptop, a desktop computer, a smartwatch, and the like.

The bus 110 may include a circuit for connecting the aforementioned constitutional elements 110 to 170 to each other and for delivering communication (e.g., a control message and/or data) between the aforementioned constitutional elements.

The processor 120 may include one or more of a Central Processing Unit (CPU), an Application Processor (AP), and a Communication Processor (CP). The processor 120 may control, for example, at least one of other constitutional elements of the electronic device 101 and/or may execute an arithmetic operation or data processing for communication. The processing (or controlling) operation of the processor 120 according to various embodiments is described in detail with reference to the following drawings.

The memory 130 may include a volatile and/or non-volatile memory. The memory 130 may store, for example, a command or data related to at least one different constitutional element of the electronic device 101. According to various exemplary embodiments, the memory 130 may store a software and/or a program 140. The program 140 may include, for example, a kernel 141, a middleware 143, an Application Programming

Interface (API) 145, and/or an application program (or an “application”) 147, or the like, configured for controlling one or more functions of the electronic device 101 and/or an external device. At least one part of the kernel 141, middleware 143, or API 145 may be referred to as an Operating System (OS). The memory 130 may include a computer-readable recording medium having a program recorded therein to perform the method according to various embodiment by the processor 120.

The kernel 141 may control or manage, for example, system resources (e.g., the bus 110, the processor 120, the memory 130, etc.) used to execute an operation or function implemented in other programs (e.g., the middleware 143, the API 145, or the application program 147). Further, the kernel 141 may provide an interface capable of controlling or managing the system resources by accessing individual constitutional elements of the electronic device 101 in the middleware 143, the API 145, or the application program 147.

The middleware 143 may perform, for example, a mediation role so that the API 145 or the application program 147 can communicate with the kernel 141 to exchange data.

Further, the middleware 143 may handle one or more task requests received from the application program 147 according to a priority. For example, the middleware 143 may assign a priority of using the system resources (e.g., the bus 110, the processor 120, or the memory 130) of the electronic device 101 to at least one of the application programs 147. For instance, the middleware 143 may process the one or more task requests according to the priority assigned to the at least one of the application programs, and thus may perform scheduling or load balancing on the one or more task requests.

The API 145 may include at least one interface or function (e.g., instruction), for example, for file control, window control, video processing, or character control, as an interface capable of controlling a function provided by the application 147 in the kernel 141 or the middleware 143.

For example, the input/output interface 150 may play a role of an interface for delivering an instruction or data input from a user or a different external device(s) to the different constitutional elements of the electronic device 101. Further, the input/output interface 150 may output an instruction or data received from the different constitutional element(s) of the electronic device 101 to the different external device.

The display 160 may include various types of displays, for example, a Liquid Crystal Display (LCD) display, a Light Emitting Diode (LED) display, an Organic Light-Emitting Diode (OLED) display, a MicroElectroMechanical Systems (MEMS) display, or an electronic paper display. The display 160 may display, for example, a variety of contents (e.g., text, image, video, icon, symbol, etc.) to the user. The display 160 may include a touch screen. For example, the display 160 may receive a touch, gesture, proximity, or hovering input by using a stylus pen or a part of a user's body.

The communication interface 170 may establish, for example, communication between the electronic device 101 and the external device (e.g., a first external electronic device 102, a second external electronic device 104, or a server 106). For example, the communication interface 170 may communicate with the external device (e.g., the 2nd external electronic device 104 or the server 106) by being connected to a network 162 through wireless communication or wired communication.

For example, as a cellular communication protocol, the wireless communication may use at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. Further, the wireless communication may include, for example, a near-distance communication 164. The near-distance communication 164 may include, for example, at least one of Wireless Fidelity (WiFi), Bluetooth, Near Field Communication (NFC), Global Navigation Satellite System (GNSS), and the like. According to a usage region or a bandwidth or the like, the GNSS may include, for example, at least one of Global Positioning System (GPS), Global Navigation Satellite System (Glonass), Beidou Navigation Satellite System (hereinafter, “Beidou”), Galileo, the European global satellite-based navigation system, and the like. Hereinafter, the “GPS” and the “GNSS” may be used interchangeably in the present document. The wired communication may include, for example, at least one of Universal Serial Bus (USB), High Definition Multimedia Interface (HDMI), Recommended Standard-232 (RS-232), power-line communication, Plain Old Telephone Service (POTS), and the like. The network 162 may include, for example, at least one of a telecommunications network, a computer network (e.g., LAN or WAN), the internet, and a telephone network.

Each of the first and second external electronic devices 102 and 104 may be the same type or different type of the electronic device 101. In an embodiment, the external electronic device 102 may be a navigation device (e.g., the “smart cane”). In one embodiment, the electronic device 102 may use a combination of sensors (e.g., the one or more sensors) to identify objects in the path of an operator, provide information associated with the identified objects to the electronic device 101, and receive directional data from the electronic device 101 that may be used to drive the motorized wheel affixed to an end of the electronic device 102 so as to guide the operator around the identified objects. Additionally, the electronic device 102 may be configured by the electronic device 101 to follow a predetermined route to facilitate point to point travel by the operator (e.g., the “user”).

According to one exemplary embodiment, the server 106 may include a group of one or more servers. According to various exemplary embodiments, all or some of the operations executed by the electronic device 101 may be executed in a different one or a plurality of electronic devices (e.g., the electronic device 102, the electronic device 104, or the server 106). According to one exemplary embodiment, if the electronic device 101 needs to perform a certain function or service either automatically or based on a request, the electronic device 101 may request at least some parts of functions related thereto alternatively or additionally to a different electronic device (e.g., the electronic device 102, the electronic device 104, or the server 106) instead of executing the function or the service autonomously. The different electronic device (e.g., the electronic device 102, the electronic device 104, or the server 106) may execute the requested function or additional function, and may deliver a result thereof to the electronic device 101. The electronic device 101 may provide the requested function or service either directly or by additionally processing the received result. For this, for example, a cloud computing, distributed computing, or client-server computing technique may be used.

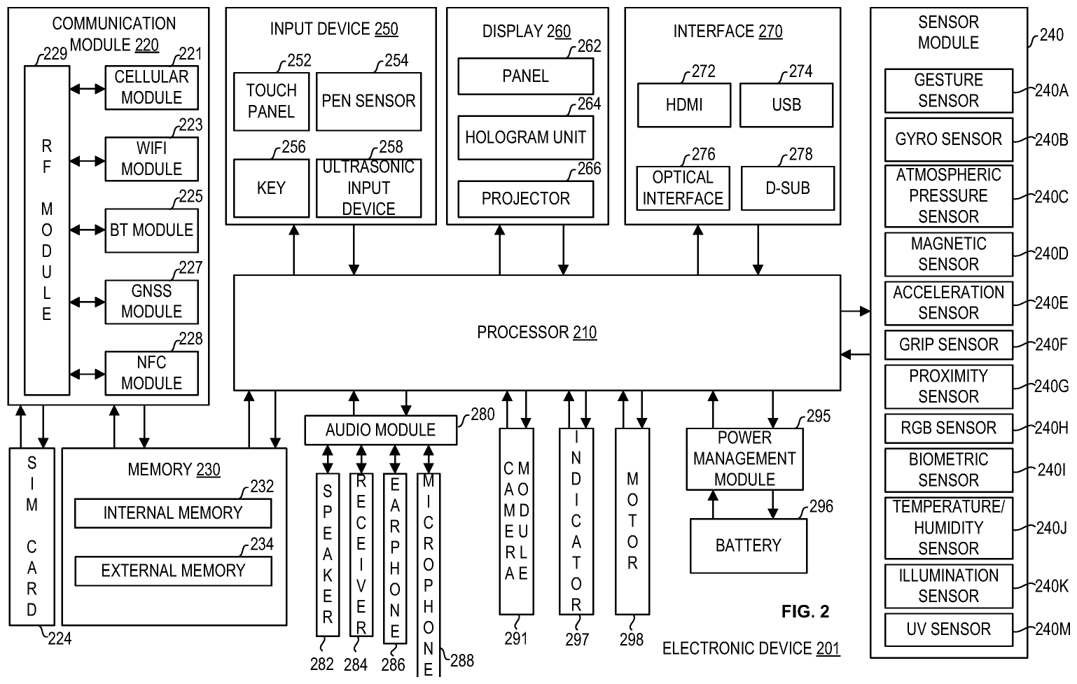

FIG. 2 is a block diagram of an electronic device according to various exemplary embodiments. An electronic device 201 may include, for example, all or some parts of the electronic device 101 of FIG. 1. The electronic device 201 may include one or more processors (e.g., Application Processors (APs)) 210, a communication module 220, a subscriber identity module 224, a memory 230, a sensor module 240, an input unit 250, a display 260, an interface 270, an audio module 280, a camera unit 291, a power management module 295, a battery 296, an indicator 297, and a motor 298.

The processor 210 may control a plurality of hardware or software constitutional elements connected to the processor 210 by driving, for example, an operating system or an application program, and may process a variety of data including multimedia data and may perform an arithmetic operation. The processor 210 may be implemented, for example, with a System on Chip (SoC). According to one exemplary embodiment, the processor 210 may further include a Graphic Processing Unit (GPU) and/or an Image Signal Processor (ISP). The processor 210 may include at least one part (e.g., a cellular module 221) of the aforementioned constitutional elements of FIG. 2. The processor 210 may process an instruction or data, which is received from at least one of different constitutional elements (e.g., a non-volatile memory), by loading it to a volatile memory and may store a variety of data in the non-volatile memory.

The communication module 220 may have a structure the same as or similar to the communication interface 170 of FIG. 1. The communication module 220 may include, for example, the cellular module 221, a Wi-Fi module 223, a BlueTooth (BT) module 225, a GNSS module 227 (e.g., a GPS module, a Glonass module, a Beidou module, or a Galileo module), a Near Field Communication (NFC) module 228, and a Radio Frequency (RF) module 229.

The cellular module 221 may provide a voice call, a video call, a text service, an internet service, or the like, for example, through a communication network. According to one exemplary embodiment, the cellular module 221 may identify and authenticate the electronic device 201 in the communication network by using the subscriber identity module (e.g., a Subscriber Identity Module (SIM) card) 224. According to one exemplary embodiment, the cellular module 221 may perform at least some functions that can be provided by the processor 210. According to one exemplary embodiment, the cellular module 221 may include a Communication Processor (CP).

Each of the WiFi module 223, the BT module 225, the GNSS module 227, or the NFC module 228 may include, for example, a processor for processing data transmitted/received via a corresponding module. According to a certain exemplary embodiment, at least some (e.g., two or more) of the cellular module 221, the WiFi module 223, the BT module 225, the GPS module 227, and the NFC module 228 may be included in one Integrated Chip (IC) or IC package.

The RF module 229 may transmit/receive, for example, a communication signal (e.g., a Radio Frequency (RF) signal). The RF module 229 may include, for example, a transceiver, a Power Amp Module (PAM), a frequency filter, a Low Noise Amplifier (LNA), an antenna, or the like. According to another exemplary embodiment, at least one of the cellular module 221, the WiFi module 223, the BT module 225, the GPS module 227, and the NFC module 228 may transmit/receive an RF signal via a separate RF module.

The subscriber identity module 224 may include, for example, a card including the subscriber identity module and/or an embedded SIM, and may include unique identification information (e.g., an Integrated Circuit Card IDentifier (ICCID)) or subscriber information (e.g., an International Mobile Subscriber Identity (IMSI)).

The memory 230 (e.g., the memory 130) may include, for example, an internal memory 232 or an external memory 234. The internal memory 232 may include, for example, at least one of a volatile memory (e.g., a Dynamic RAM (DRAM), a Static RAM (SRAM), a Synchronous Dynamic RAM (SDRAM), etc.) and a non-volatile memory (e.g., a One Time Programmable ROM (OTPROM), a Programmable ROM (PROM), an Erasable and Programmable ROM (EPROM), an Electrically Erasable and Programmable ROM (EEPROM), a mask ROM, a flash ROM, a flash memory (e.g., a NAND flash memory, a NOR flash memory, etc.), a hard drive, or a Solid State Drive (SSD)).

The external memory 234 may further include a flash drive, for example, Compact Flash (CF), Secure Digital (SD), Micro Secure Digital (Micro-SD), Mini Secure digital (Mini-SD), extreme Digital (xD), memory stick, or the like. The external memory 234 may be operatively and/or physically connected to the electronic device 201 via various interfaces.

The sensor module 240 may measure, for example, physical quantity or detect an operational status of the electronic device 201, and may convert the measured or detected information into an electric signal. The sensor module 240 may include, for example, at least one of a gesture sensor 240A, a gyro sensor 240B, a pressure sensor 240C, a magnetic sensor 240D, an acceleration sensor 240E, a grip sensor 240F, a proximity sensor 240G, a color sensor 240H (e.g., a Red, Green, Blue (RGB) sensor), a bio sensor 240I, a temperature/humidity sensor 240J, an illumination sensor 240K, an Ultra Violet (UV) sensor 240M, an ultrasonic sensor 240N, and an optical sensor 240P. According to one exemplary embodiment, the optical sensor 240P may detect ambient light and/or light reflected by an external object (e.g., a user's finger. etc.), and which is converted into a specific wavelength band by means of a light converting member. Additionally or alternatively, the sensor module 240 may include, for example, an E-nose sensor, an ElectroMyoGraphy (EMG) sensor, an ElectroEncephaloGram (EEG) sensor, an ElectroCardioGram (ECG) sensor, an Infrared (IR) sensor, an iris sensor, and/or a fingerprint sensor. The sensor module 240 may further include a control circuit for controlling at least one or more sensors included therein. In a certain exemplary embodiment, the electronic device 201 may further include a processor configured to control the sensor module 204 either separately or as one part of the processor 210, and may control the sensor module 240 while the processor 210 is in a sleep state.

The input device 250 may include, for example, a touch panel 252, a (digital) pen sensor 254, a key 256, or an ultrasonic input device 258. The touch panel 252 may recognize a touch input, for example, by using at least one of an electrostatic type, a pressure-sensitive type, and an ultrasonic type. In addition, the touch panel 252 may further include a control circuit. The touch penal 252 may further include a tactile layer and thus may provide the user with a tactile reaction.

The (digital) pen sensor 254 may be, for example, one part of a touch panel, or may include an additional sheet for recognition. The key 256 may be, for example, a physical button, an optical key, a keypad, or a touch key. The ultrasonic input device 258 may detect an ultrasonic wave generated from an input means through a microphone (e.g., a microphone 288) to confirm data corresponding to the detected ultrasonic wave.

The display 260 (e.g., the display 160) may include a panel 262, a hologram unit 264, or a projector 266. The panel 262 may include a structure the same as or similar to the display 160 of FIG. 1. The panel 262 may be implemented, for example, in a flexible, transparent, or wearable manner. The panel 262 may be constructed as one module with the touch panel 252. According to one exemplary embodiment, the panel 262 may include a pressure sensor (or a force sensor) capable of measuring strength of pressure for a user's touch. The pressure sensor may be implemented in an integral form with respect to the touch panel 252, or may be implemented as one or more sensors separated from the touch panel 252.

The hologram unit 264 may use an interference of light and show a stereoscopic image in the air. The projector 266 may display an image by projecting a light beam onto a screen. The screen may be located, for example, inside or outside the electronic device 201. According to one exemplary embodiment, the display 260 may further include a control circuit for controlling the panel 262, the hologram unit 264, or the projector 266.

The interface 270 may include, for example, a High-Definition Multimedia Interface (HDMI) 272, a Universal Serial Bus (USB) 274, an optical communication interface 276, or a D-subminiature (D-sub) 278. The interface 270 may be included, for example, in the communication interface 170 of FIG. 1. Additionally or alternatively, the interface 270 may include, for example, a Mobile High-definition Link (MHL) interface, a Secure Digital (SD)/Multi-Media Card (MMC) interface, or an Infrared Data Association (IrDA) standard interface.

The audio module 280 may bilaterally convert, for example, a sound and electric signal. At least some constitutional elements of the audio module 280 may be included in, for example, the input/output interface 150 of FIG. 1. The audio module 280 may convert sound information which is input or output, for example, through a speaker 282, a receiver 284, an earphone 286, the microphone 288, or the like.

The camera module 291 is, for example, a device for image and video capturing, and according to one exemplary embodiment, may include one or more image sensors (e.g., a front sensor or a rear sensor), a lens, an Image Signal Processor (ISP), or a flash (e.g., LED or xenon lamp).

The power management module 295 may manage, for example, power of the electronic device 201. According to one exemplary embodiment, the power management module 295 may include a Power Management Integrated Circuit (PMIC), a charger Integrated Circuit (IC), or a battery fuel gauge. The PMIC may have a wired and/or wireless charging type. The wireless charging type may include, for example, a magnetic resonance type, a magnetic induction type, an electromagnetic type, or the like, and may further include an additional circuit for wireless charging, for example, a coil loop, a resonant circuit, a rectifier, or the like. The battery gauge may measure, for example, residual quantity of the battery 296 and voltage, current, and temperature during charging. The battery 296 may include, for example, a rechargeable battery and/or a solar battery.

The indicator 297 may display a specific state, for example, a booting state, a message state, a charging state, or the like, of the electronic device 201 or one part thereof (e.g., the processor 210). The motor 298 may convert an electric signal into a mechanical vibration, and may generate a vibration or haptic effect. Although not shown, the electronic device 201 may include a processing device (e.g., a GPU) for supporting a mobile TV. The processing device for supporting the mobile TV may process media data conforming to a protocol of, for example, Digital Multimedia Broadcasting (DMB), Digital Video Broadcasting (DVB), MediaFlo™, or the like.

Each of constitutional elements described in the present document may consist of one or more components, and names thereof may vary depending on a type of an electronic device. The electronic device according to various exemplary embodiments may include at least one of the constitutional elements described in the present document. Some of the constitutional elements may be omitted, or additional other constitutional elements may be further included. Further, some of the constitutional elements of the electronic device according to various exemplary embodiments may be combined and constructed as one entity, so as to equally perform functions of corresponding constitutional elements before combination.

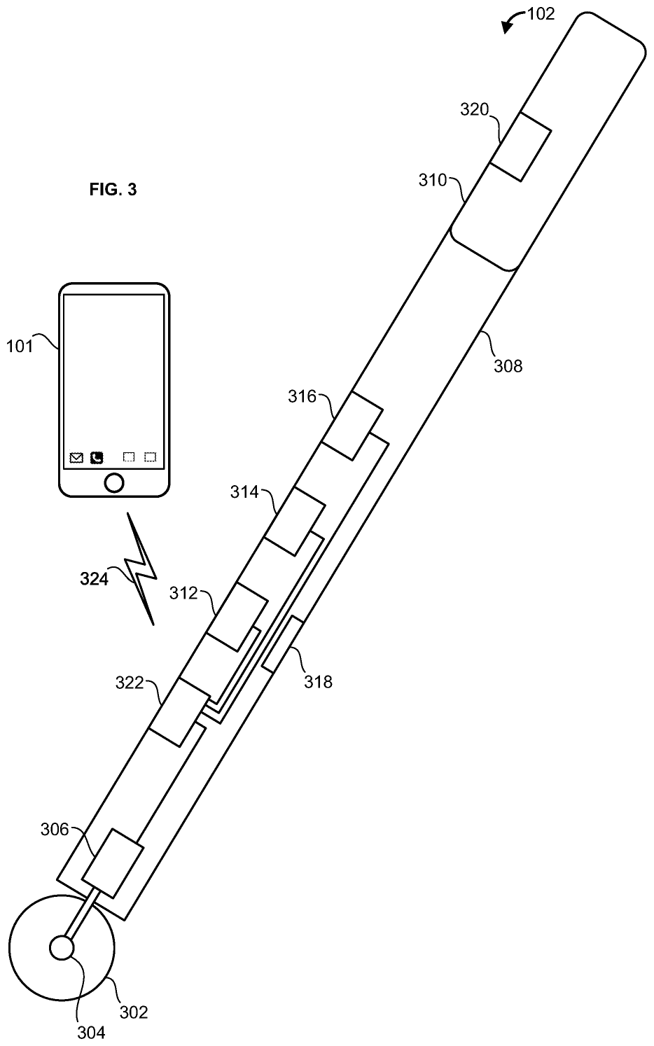

FIG. 3 shows an example apparatus (e.g., the electronic device 102). The electronic device 102 may comprise a motorized wheel assembly comprising at least one wheel 302. The at least one wheel (e.g., the “wheel”) may comprise a single omni-directional wheel. The wheel 302 may comprise a rubber wheel. An axle 304 may extend from at least one side of the wheel 302. A motor 306 may be configured to rotate the wheel 302 via a drive shaft (or other motion transfer system, e.g., chain). The electronic device 102 may comprise a walking cane 308 connected to the wheel assembly (e.g., via the axle 304) at a proximal end, the walking cane 308 extending away from the wheel assembly toward a handle 310 positioned at a distal end of the walking cane 308, the handle 310 being configured to be gripped by a user. A tactile feedback device 320 may be embedded in the handle 310. In one embodiment, the handle 310 may have an integrated accelerator/decelerator configured to drive the motor 306.

The electronic device 102 may comprise one or more sensors. In one embodiment, the one or more sensors may include one or more of LIDAR sensors, radar sensors, ultrasonic sensors, accelerometers, proximity sensors, infrared sensors, imaging sensors, GPS sensors, optical flow sensors, combinations thereof, and the like. The electronic device 102 may comprise a Light Detection and Ranging (LIDAR) sensor 312, affixed to the walking cane 308. The LIDAR sensor 312 may be configured for detecting an environment in a path of the electronic device 102 and generating LIDAR data. The LIDAR sensor 312 may be a Garmin /Sparkfun Lidar laser V3 with a range of one hundred and thirty-one feet. While sensor 312 is described throughout this disclosure as being a LIDAR sensor, it is to be understood that sensor 312 may also comprise a radar sensor, sonar sensor, or other similar sensor.

The electronic device 102 may comprise a light source 318 positioned opposite the LIDAR sensor 312. The light source 318 may output light so as to illuminate the surface immediately in the front of the user. For example, a low-vision user may not be totally blind and thus benefit from the light source 318 illuminating the surface where the low-vision user is walking. The light source 318 may comprise, for example a halogen light source, an LED light source, an incandescent light source, combinations thereof, and the like. The light source 318 may be in communication with any of the sensors described herein. For example, the light source 318 may be configured to emit a first light (white), and, upon detection of an object in the path by, for example, the LIDAR sensor, emit a second light (red) so as to alert the low vision user that an object has been detected and thus a change in direction may be imminent. In a similar fashion, the light source 318 may be configured to provide directional lighting (e.g., in the form an arrow projected on the ground) to indicate a direction of travel around an object or in accordance with turn-by-turn directions.

The electronic device 102 may comprise an ultrasonic sensor 314 (e.g., sonar) affixed to the walking cane 308. The ultrasonic sensor 314 may be configured for detecting the environment in the path of the electronic device 102 and generating ultrasonic data. The ultrasonic sensor 314 may be a Mini guide ultrasonic sensor from GDP Research which provides backup tactile feedback as a form of verification to the primary LIDAR sensor. This sensor may be configured to transmit tactile feedback to the tactile feedback device 320 as described further herein. The ultrasonic sensor may comprise an ultrasonic output and an ultrasonic receiver. The ultrasonic sensor may be configured to emit an ultrasonic signal (e.g., a soundwave). For example, the ultrasonic sensor may output an ultrasonic signal (e.g., at a volume and frequency). The ultrasonic signal may travel through a medium (e.g., the air) and strike a surface (e.g., an object) in the path of the electronic device 102. The ultrasonic may reflect off the surface and be detected by the ultrasonic receiver. The reflected ultrasonic signal may have a different volume (due to, for example, signal degradation over time and distance in the air) or a change in frequency (due to partial absorption by the object).

The electronic device 102 may comprise an optical flow sensor 316 affixed to the walking cane. The optical flow sensor 316 may be configured for detecting a pattern of apparent motion associated with the environment in the path of the electronic device 102 caused by the motion of the optical flow sensor 316 relative to the surface and/or nearby objects and generating optical flow data. The optical flow sensor 316 may be a JeVios camera, which can provide a detailed optical flow scan of the surface. The optical flow scan may detail drop-offs, hole, bumps and other surface imperfections. Similarly, the optical flow sensor 316 may be configured for determining objects through object recognition or other known techniques (e.g., edge detection, background subtraction, or other similar techniques). The optical flow sensor 316 may provide verification of the other sensors.

The electronic device 102 may comprise a power source (not shown) configured to power the motor 306 and other electronics of the electronic device 102. For example, the power source may be a battery, a solar cell, a hydrogen cell, a fuel powered engine, combinations thereof, and the like.

The electronic device 102 may comprise a computing device (e.g., the electronic device 101) affixed to the walking cane 308. The computing device may be a smartphone, a smart watch, a smart glass, a tablet, a laptop, combinations thereof, and the like. The electronic device 102 may comprise a mount (not shown) or other system for affixing the electronic device 101 to the walking cane 308. In an embodiment, the electronic device 101 is not affixed to the walking cane 308. The electronic device 101 may be configured to determine the path of the electronic device 102, engage the motor 306 to cause the electronic device 102 to proceed along the path, receive the LIDAR data, the ultrasonic data, and the optical flow data, determine, based on one or more of the LIDAR data, the ultrasonic data, or the optical flow data, one or more objects in the path of the electronic device 102, and engage the motor 306 to cause the electronic device 102 to avoid the one or more objects. The electronic device 101 may be configured to transmit the one or more of the LIDAR data, the ultrasonic data, or the optical flow data to a server.

The electronic device 101 may comprise a GPS component (e.g., the GNSS module 227). In various embodiments, the electronic device 101 may use the GPS component to determine turn-by-turn guidance associated with the path and output, via the tactile feedback device 320, a vibration output associated with the turn-by-turn guidance associated with the path. In various embodiments, the electronic device 101 may use the GPS component to determine turn-by-turn guidance associated with the path and output, via a speaker (e.g., the speaker 282), voice output associated with the turn-by-turn guidance associated with the path. For example, the speaker may output audible directions associated with, for example, making right and/or left turns, progressing down the path for a certain distance or period of time, combinations thereof, and the like.

To determine the one or more objects in the path of the apparatus, the electronic device 101 may be configured to determine, based on the LIDAR data, a position of an object, confirm, based on the ultrasonic data, the position of the object, and confirm, based on the optical flow data, the position of the object. The electronic device 101 may be configured to determine directional data based on the determination of the one or more objects in the path of the electronic device 102. The electronic device 101 may be configured to repeat this process so as to continually update the position of the object relative to the smart cane (and by extension, the user).

The electronic device 102 may further comprise a second computing device (e.g., processor 322), in communication with the computing device. The processor 322 may comprise the wireless network interface. The wireless network interface may be a Bluetooth connection, an antenna, or other suitable interface. In one embodiment, the wireless network interface is a Bluetooth Low Energy (BLE) module. In one non-limiting example, the wireless network interface and the processor 322 are integrated in one unitary component, such as a RFduino microcontroller with built-in BLE module, a Nordic Semiconductor microcontroller, a Cypress microcontroller with BLE module, or a BLE enabled Raspberry Pi. The processor 322 may be configured to receive sensor data (environmental information) from each of the various sensors of the electronic device 102 (e.g., any of the components of the sensor module 240). The processor 322 may provide some or all of the environmental information to the electronic device 101 over a wireless connection 324. The processor 322 may provide some or all of the environmental information to the electronic device 101 over a wired connection (not shown).

The processor 322 may be configured to receive, from the electronic device 101, the directional data and engage, based on the directional data, the motor 306. In one embodiment, the processor 322 transmits and/or receives data via a wireless network interface to and/or from an external device (e.g., the electronic device 101). For example, based on the directional data, the processor 322 may determine the surface in front of the smart cane is clear of obstructions (e.g., no objects in the path have been identified) and thus engage the motor 306 in a manner so as to move the smart cane forward along the path. Likewise, the processor 322 may determine, based on the optical flow analysis, that an object is obstructing the path and thus may engage the motor 306 to stop and/or redirect the wheel 302.

In operation, the electronic device 101 may analyze environmental information (e.g., the LIDAR data, the ultrasonic data, and/or the optical flow data), control the motor 306 based on the environmental information, and provide feedback to the operator of the electronic device 102. Haptic or auditory feedback may be provided to the operator to indicate how to navigate through the environment. In one embodiment, feedback may be provided to the operator to facilitate the operator following a predetermined route. This can be accomplished by the electronic device 101 identifying a predetermined route and receiving and analyzing GPS information to provide feedback to the operator regarding macro adjustments to the current route (e.g., turn right, turn left). For example, if the GPS information indicates that, in order to stay on the path, the user must make a left turn, a left side of the tactile feedback device 320 may be activated. Likewise, if the GPS information indicates that, in order to avoid an object, the user must move to the right, a right side of the tactile feedback device 320 may be activated. The electronic device 101 also analyzes sensor data to provide feedback to the operator regarding micro adjustments to the current route (e.g., step down, step up, veer right, veer left, stop, etc.). Micro adjustments can advantageously allow the operator to avoid obstacles while maintaining course. Moreover, in one embodiments, the motor 306 may be controlled by the electronic device 101 (e.g., via the processor 322) to turn the wheel 302 and propel the electronic device 102 and thereby pull the operator along a predetermined route. The electronic device 101 may use the environmental information to control the motor 306 such that the electronic device 102 pulls the operator out of the way of detected objects along the path.

In an embodiment, the processor 322 may be in communication with the electronic device 101. The processor 322 may communicate with the electronic device 101 to send the environmental information to the electronic device 101 and to receive operating instructions from the electronic device 101. For example, the electronic device 101 may include a GPS capability and a maps application (e.g., Google Maps™) that creates a route for the operator of the electronic device 102. In such an embodiment, the electronic device 101 sends instructions to the processor 322 of the electronic device 102 and the processor 322 of the electronic device 102 carries out those instructions, for example to provide route feedback to the operator of the electronic device 102. In combination with the electronic device 101 managing the route, the electronic device 102 may utilize the processor 322 to monitor environmental information received from the various sensors (the LIDAR sensor 312, the ultrasonic sensor 314, and/or the optical flow sensor 316), provide the environmental information to the electronic device 101, and receive directional data from the electronic device 101 based on the environmental information.

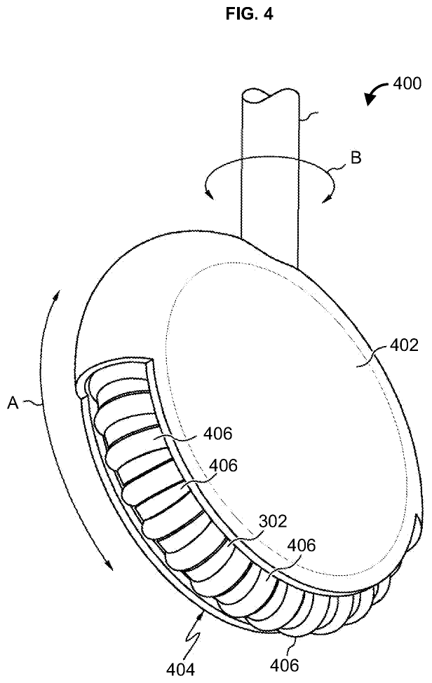

FIG. 4 illustrates a motorized wheel assembly 400 comprising the omni-directional wheel 302 depicted in FIG. 3. Although embodiments may be described herein in the context of motorized wheel assemblies having a single omni-directional wheel, embodiments are not limited thereto. The motorized wheel assembly may have any number of wheels that may be used to support and aid the user. For example, three or four motorized wheels may be used such that the electronic device 102 may remain in an upright position.

Referring to FIG. 4, the motorized wheel assembly 400 may comprise a motorized omni-directional wheel 302 that is disposed within a wheel housing 402 having an opening 404 through which the omni-directional wheel 302 may contact a supporting surface such as a floor (e.g., the surface). The wheel housing 402 may be made of a metal material such as stainless steel or aluminum, for example, or a molded plastic material. The motorized omni-directional wheel 302 may be configured as a wheel around a circumference of which a plurality of gripping elements 406 may be positioned. The wheel 302 may be made of rubber, metal, or a rigid plastic material. The wheel 302 may be rotated in an angular direction depicted by arrow A by the application of one or more drive signals provided by the electronic device 101 to the drive motor 306. The rotation of the wheel 302 in the angular direction A causes the electronic device 102 to travel in a forward or backward direction. Likewise, rotation of the wheel 302 about an axis perpendicular to the surface (e.g., the angular direction B) may cause the electronic device 102 to change course (e.g., in change direction in relation to the path).

Directional data received from the electronic device 101 (e.g., drive signals) may be provided to the motorized omni-directional wheel 302 such that the rotation of the wheel 302 enables the electronic device 102 to travel in a plurality of directions such that the electronic device 102 may move in accordance with a user's intended direction of travel, as well as move to avoid detected objects. Other omni-directional wheel configurations and controls may also be incorporated into the motorized wheel assembly 400, and embodiments are not limited to the omni-directional wheel illustrated in FIG. 4. In one embodiment, the motorized wheel assembly 400 may be rotatably coupled to the walking cane 308 such that the wheel 302 may be controllably rotated in a direction as indicated by arrow B to provide omni-directional functionality. In this embodiment, the motorized wheel assembly 400 may turn in the direction of the intended direction of travel of the user and/or in the direction that avoids an object along a path. In one embodiment, the gripping elements 406 may be movable (e.g., rotatable) such that one or more of the gripping elements 406 may rotate around the circumference on which the gripping elements 406 are positioned. For example, in such an embodiment, the gripping elements may comprise wheels, rings, bearings, or the like. For example, even if the wheel 302 is not rotating in the angular direction A, or the angular direction B, one or more of the gripping elements 406 may rotate around the circumference of the wheel 302 so as to move the proximal end of the smart cane left or right relative to the orientation of the wheel 302 (e.g., relative to direction A). For example, if the direction of travel of the smart cane is forward, and an object is determined to be obstructing the path, the wheel 302 may stop rotating and one or more of the gripping elements 406 may rotate so as to maneuver the proximal end of the smart cane to the left or right (relative to the direction of travel) until the proximal end of the smart cane is in a position to move forward without contacting the object. The one or more gripping elements 406 may be powered by a gripping element motor (not shown) contained within the wheel 302.

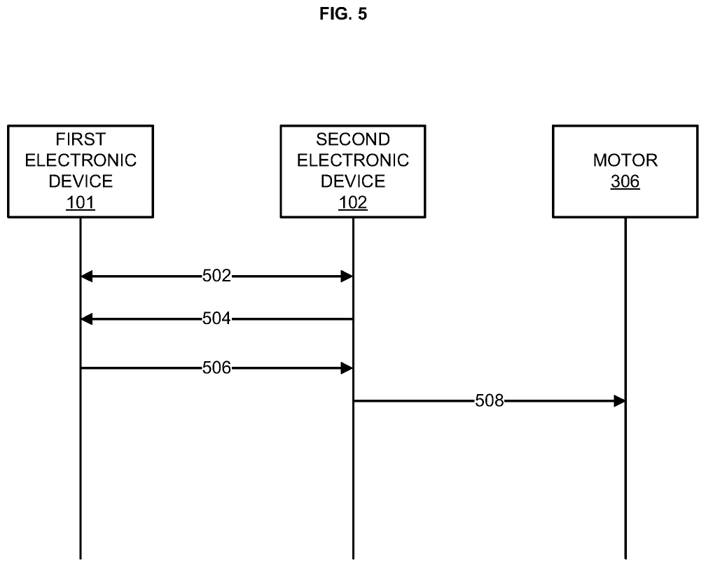

FIG. 5 illustrates a process for navigation according to various embodiments of the present disclosure. The first electronic device 101 (e.g., a smartphone) may open a communication session with a second electronic device 102 (e.g., a smart cane) at 502. For example, the communication session may be a wireless communication session such as a Bluetooth communication session. At 504, the second electronic device 102 may gather environmental data from one or more sensors and send the environmental data to the first electronic device 101. For example, the one or more sensors may determine the environmental data and relay the environmental data to the first electronic device 101. For example, the LIDAR sensor 312, the ultrasonic sensor 314, and optical flow sensor 316 may determine the environmental data via the techniques described herein. The environmental data may indicate a presence of one or more objects in proximity to the second electronic device 102. The first electronic device 101 may analyze the environmental data and generate directional data based on the environmental data. The directional data may indicate a direction and/or a distance (e.g., a vector) that the second electronic device 102 needs to travel in order to avoid the one or more objects in proximity to the second electronic device 102. At 506, the first electronic device 101 may send the directional data to the second electronic device 102. The second electronic 102 device may process the directional data.

The second electronic device 102 may determine one or more drive signals based on the directional data. The one or more drive signals may be used to control a direction and a distance that the motor 306 drives the wheel 302. For example, the one or more drive signals may indicate a period of time for which the wheel 302 or one or more of the gripping elements 406 should rotate. For example, the one or more drive signals may indicate a speed (e.g., velocity, angular velocity, rotations per unit time) at which the wheel 302 or one or more of the gripping elements 406 should rotate. For example, the one or more drive signals may indicate a direction (e.g., the direction A, the direction B, or some other direction) the wheel 302 or one or more of the gripping elements 406 should rotate. At 508, the second electronic device 102 may provide the one or more drive signals to the motor 306. The motor 306 may control the wheel 302 according to the one or more drive signals. For example, the motor 306 may cause the wheel 302 or one or more of the gripping elements 406 to rotate in a particular direction (e.g., the rotational direction A, forward or backward, or at some angle relative to the direction of travel indicated by the path).

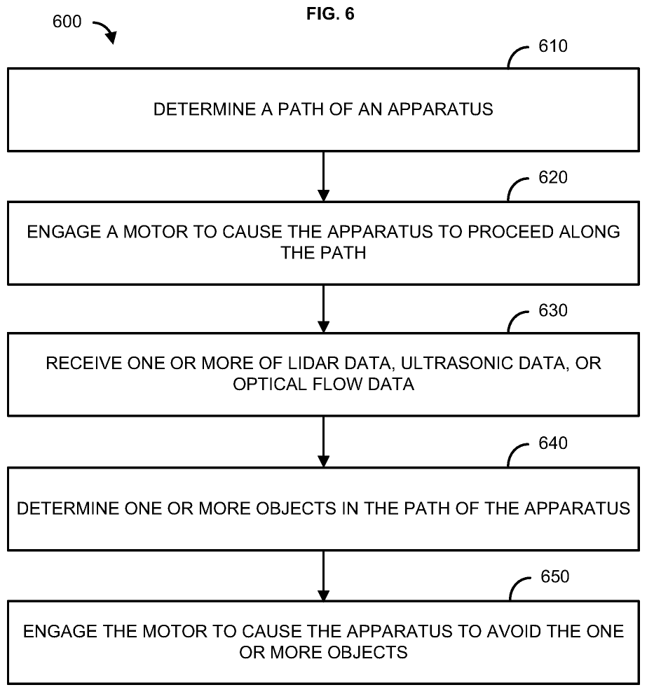

FIG. 6 shows an example method 600. The method 600 may be executed by any of the devices described herein or any combination thereof (e.g., any of the electronic device 101, the electronic device 102, the electronic device 104, and/or the electronic device 201). The method 600 may comprise determining a path of an apparatus at 610. The path may comprise a direction of travel, navigational information associated with a destination, turn-by-turn directions, combinations thereof, and the like. The path may be determined based on GPS information. For example, the GPS information may comprise a map and/or directions to a destination. The path of the apparatus may comprise a route between a present location of the smart cane (and be extension, the user) and the destination.

The method 600 may comprise engaging a motor to cause the apparatus to proceed along the path at 620. Engaging the motor to cause the apparatus to proceed along the path may comprise sending, to the motor one or more drive signals. The one or more drive signals may cause a wheel (e.g., the wheel 302) to rotate about an axis in a direction (e.g., the angular direction A or the angular direction B). The one or more drive signals may cause one or more of the gripping elements 406 to rotate about the circumference of the wheel 302 so as to maneuver the proximal end of the smart cane in a direction (e.g., left or right) relative to the direction of travel along the path (e.g., forward or backwards along angular direction A). The one or more drive signals may cause the wheel 302 to rotate about an axis which extends through the wheel 302 perpendicular to the surface such that the direction of travel may be changed (e.g., as one or more degrees left or right of center).

The method 600 may comprise receiving one or more of LIDAR data, ultrasonic data, or optical flow data at 630. The one or more of LIDAR data, ultrasonic data, or optical flow data may be determined by the LIDAR sensor 312, the ultrasonic sensor 314, and the optical flow sensor 316 as described herein. The LIDAR sensor 312, the ultrasonic sensor 314, and the optical flow sensor 316 may determine the LIDAR data, ultrasonic data, or optical flow data and send the LIDAR data, the ultrasonic data, and the optical flow data to a computing device (e.g., the electronic device 101) for processing. For example, the LIDAR sensor 312 may emit a light and in response, receive a light signal. The LIDAR sensor 312 may determine a time of flight or change in frequency associated with the emitted light signal and the received light signal. Similarly, the ultrasonic sensor 314 may emit an ultrasonic signal (e.g., a sound wave) and receive a reflected ultrasonic signal. The optical flow analysis sensor 316 may determine the presence of objects proximate the smart cane via, for example, object recognition technologies. For example, the optical flow analysis sensor 316 may comprise a camera and a processor. The camera may capture image data (e.g., still images or video comprising one or more video frames).

The method 600 may comprise determining, based on one or more of the LIDAR data, the ultrasonic data, or the optical flow data, one or more objects in the path of the apparatus at 640. For example, the electronic device 101 may receive, from the LIDAR sensor, a time of flight or change in frequency associated with the emitted light signal and the received light signal and thereby determine a distance between the LIDAR sensor 312 and an object. For example, the electronic device may receive, from the ultrasonic sensor 314, a time difference between the emitted ultrasonic signal and the received ultrasonic signal, and/or degradation of the ultrasonic signal and thereby determine a distance between the ultrasonic sensor and an object. The optical flow analysis sensor 316 send the image data to the electronic device 101 (or any other suitable device as described herein) and the electronic device 101 (or any other suitable device) may determine the presence of objects via known methods such as edge detection, computer vision, histogram analysis, background subtraction, frame differencing, temporal difference, optical flow or any other appropriate technique as is known in the art. Determining the one or more objects in the path of the apparatus may comprise determining, based on the LIDAR data, a position of an object, confirming, based on the ultrasonic data, the position of the object, and confirming, based on the optical flow data, the position of the object.

The method 600 may comprise engaging the motor to cause the apparatus to avoid the one or more objects at 650. For example, based on the LIDAR data, the ultrasonic data, and the optical flow data, the electronic device may determine one or more drive signals that may indicate a period of time for which the wheel 302 or one or more of the gripping elements 406 should rotate. For example, the one or more drive signals may indicate a speed (e.g., velocity, angular velocity, rotations per unit time) at which the wheel 302 or one or more of the gripping elements 406 should rotate. For example, the second electronic device 102 may provide the one or more drive signals to the motor 306. The motor 306 may control the wheel 302 according to the one or more drive signals. For example, the motor 306 may cause the wheel 302 or one or more of the gripping elements 406 to rotate in a particular direction (e.g., the angular direction A, forward or backward, or at some angle relative to the direction of travel indicated by the path). For example, that one or more of the gripping elements 406 may rotate around the circumference on which the gripping elements 406 are positioned. For example, the gripping elements may comprise wheels, rings, bearings, or the like. For example, even if the wheel 302 is not rotating in the angular direction A, one or more of the gripping elements 406 may rotate around the circumference so as to move the proximal end of the smart cane left or right relative to the path. For example, if the direction of travel of the smart cane is forward, and an object is determined to be obstructing the path, the wheel 302 may stop rotating and one or more of the gripping elements 406 may rotate so as to maneuver the proximal end of the smart cane to the left or right (relative to the direction of travel) until the proximal end of the smart cane is in a position to move forward without contacting the object. The one or more gripping elements 406 may be powered by a gripping element motor (not shown) contained within the wheel 302.

The method 600 may further comprise transmitting one or more of the LIDAR data, the ultrasonic data, or the optical flow data to a server.

The method 600 may further comprise determining turn-by-turn guidance associated with the path and outputting, via a tactile feedback device, a vibration output associated with the turn-by-turn guidance associated with the path.

The method 600 may further comprise determining turn-by-turn guidance associated with the path and outputting, via a speaker, voice output associated with the turn-by-turn guidance associated with the path.

The method 600 may further comprise determining, based on the one or more objects in the path of the apparatus, directional data, transmitting, to computing device, the directional data, and engaging, by the computing device and based on the directional data, the motor.

The apparatus may comprise a wheel, an axle extending from at least one side of the wheel, a motor configured to rotate the wheel, a walking cane connected to the axle at a proximal end, the walking cane extending away from the axle toward a handle positioned at a distal end of the walking cane, the handle configured to be gripped by an operator, a Light Detection and Ranging (LIDAR) sensor, affixed to the walking cane, configured for detecting an environment in a path of the apparatus and generating the LIDAR data, an ultrasonic sensor affixed to the walking cane, affixed to the walking cane, configured for detecting the environment in the path of the apparatus and generating the ultrasonic data, and an optical flow sensor affixed to the walking cane, affixed to the walking cane, configured for detecting a pattern of apparent motion associated with the environment in the path of the apparatus caused by the motion of the optical flow sensor and generating the optical flow data.

For purposes of illustration, application programs and other executable program components are illustrated herein as discrete blocks, although it is recognized that such programs and components can reside at various times in different storage components. An implementation of the described methods can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. An apparatus, comprising:
a wheel;
an axle extending from at least one side of the wheel;
a motor configured to rotate the wheel;
a walking cane connected to the axle at a proximal end, the walking cane extending away from the axle toward a handle positioned at a distal end of the walking cane, the handle configured to be gripped by an operator;
a Light Detection and Ranging (LIDAR) sensor, affixed to the walking cane, configured for detecting an environment in a path of the apparatus and generating LIDAR data;
an ultrasonic sensor affixed to the walking cane, configured for detecting the environment in the path of the apparatus and generating ultrasonic data;
an optical flow sensor affixed to the walking cane, configured for detecting a pattern of apparent motion associated with the environment in the path of the apparatus caused by the motion of the optical flow sensor and generating optical flow data;
a computing device affixed to the walking cane, wherein the computing device is configured to:
determine the path of the apparatus;
engage the motor to cause the apparatus to proceed along the path;
receive the LIDAR data, the ultrasonic data, and the optical flow data;
determine, based on one or more of the LIDAR data, the ultrasonic data, or the optical flow data, one or more objects in the path of the apparatus; and
engage the motor to cause the apparatus to avoid the one or more objects.

2. The apparatus of claim 1, further comprising a mount configured to receive the computing device.

3. The apparatus of claim 1, wherein the computing device is further configured to transmit the one or more of the LIDAR data, the ultrasonic data, or the optical flow data to a server.

4. The apparatus of claim 1, further comprising a light source positioned opposite the LIDAR sensor.

5. The apparatus of claim 1, further comprising a tactile feedback device embedded in the handle.

6. The apparatus of claim 7, wherein the computing device comprises a GPS component configured to:
determine turn-by-turn guidance associated with the path; and
output, via the tactile feedback device, a vibration output associated with the turn-by-turn guidance associated with the path.

7. The apparatus of claim 1, wherein the computing device comprises a GPS component configured to:
determine turn-by-turn guidance associated with the path; and
output, via a speaker, voice output associated with the turn-by-turn guidance associated with the path.

8. The apparatus of claim 1, wherein the computing device is a smartphone, a smart watch, a smart glass, a tablet, or a laptop.

9. The apparatus of claim 1, wherein the wheel comprises a three-inch diameter rubber wheel.

10. The apparatus of claim 1, wherein the walking cane has a diameter of about ⅝ inches.

11. The apparatus of claim 1, wherein to determine the one or more objects in the path of the apparatus, the computing device is configured to:
determine, based on the LIDAR data, a position of an object;
confirm, based on the ultrasonic data, the position of the object; and
confirm, based on the optical flow data, the position of the object.

12. The apparatus of claim 1, wherein the computing device is configured to determine directional data based on the determination of the one or more objects in the path of the apparatus.

13. The apparatus of claim 12, further comprising a second computing device, in communication with the computing device, wherein the second computing device is configured to:
receive, from the computing device, the directional data; and
engage, based on the directional data, the motor.

14. A method comprising:
determining a path of an apparatus;
engaging a motor to cause the apparatus to proceed along the path;
receiving one or more of LIDAR data, ultrasonic data, or optical flow data;
determining, based on one or more of the LIDAR data, the ultrasonic data, or the optical flow data, one or more objects in the path of the apparatus; and
engaging the motor to cause the apparatus to avoid the one or more objects.

15. The method of claim 14, wherein the apparatus comprises:
a wheel;
an axle extending from at least one side of the wheel;
a motor configured to rotate the wheel;
a walking cane connected to the axle at a proximal end, the walking cane extending away from the axle toward a handle positioned at a distal end of the walking cane, the handle configured to be gripped by an operator;
a Light Detection and Ranging (LIDAR) sensor, affixed to the walking cane, configured for detecting an environment in a path of the apparatus and generating the LIDAR data;
an ultrasonic sensor affixed to the walking cane, affixed to the walking cane, configured for detecting the environment in the path of the apparatus and generating the ultrasonic data; and
an optical flow sensor affixed to the walking cane, affixed to the walking cane, configured for detecting a pattern of apparent motion associated with the environment in the path of the apparatus caused by the motion of the optical flow sensor and generating the optical flow data.

16. The method of claim 14, further comprising transmitting one or more of the LIDAR data, the ultrasonic data, or the optical flow data to a server.

17. The method of claim 14, further comprising:
determining turn-by-turn guidance associated with the path; and
outputting, via a tactile feedback device, a vibration output associated with the turn-by-turn guidance associated with the path.

18. The method of claim 14, further comprising:
determining turn-by-turn guidance associated with the path; and
outputting, via a speaker, voice output associated with the turn-by-turn guidance associated with the path.

19. The method of claim 14, wherein determining the one or more objects in the path of the apparatus comprises:
determining, based on the LIDAR data, a position of an object;
confirming, based on the ultrasonic data, the position of the object; and
confirming, based on the optical flow data, the position of the object.

20. The method of claim 14, further comprising:
determining, based on the one or more objects in the path of the apparatus, directional data;
transmitting, to computing device, the directional data; and
engaging, by the computing device and based on the directional data, the motor.
